(19) United States
(12) Patent Application Publication
(10) Pub. No.: US 2018/0335805 A1
(43) Pub. Date: Nov. 22, 2018

(54) MOBILE COMPUTING DEVICE PROTECTOR

(71) Applicant: Mobile Tech, Inc., Lake Oswego, OR (US)

(72) Inventors: Eric Charlesworth, Forest Grove, OR (US); Peter Schuft, Portland, OR (US)

(21) Appl. No.: 15/600,642

(22) Filed: May 19, 2017

(51) Int. Cl. G06F 1/16

(52) U.S. Cl. CPC G06F 1/1656; G06F 1/1626; A45C 2011/003; G06F 1/1613; G06F 1/1633; G06F 1/16

(57) ABSTRACT

A system capable of protecting at least a portion of the computing device may comprise a liner substantially comprising an elastic material having predetermined Shore durometer measurement. The liner may fit adjacent to a non-display side of a mobile computing device. The system may further comprise a bezel capable of fitting around at least a portion of a perimeter of the display side of a mobile computing device.

### BACKGROUND

### 1. Field

This disclosure relates generally to covers and/or enclosures to protect particular types of mobile devices during their operation and/or use.

### 2. Information

As mobile computing devices continue to increase in capability and functionality, for example, deployment of mobile computing devices in offices, hospitals, industrial settings, and other types of environments, also continues to increase. In some instances, to assist in obtaining and/or maintaining an advantage over competitors, a business may place a premium on obtaining the most capable and/or most up-to-date mobile computing devices as soon as those devices become available. However, although many types of mobile computing devices, such as tablet computing devices, for example, continue to decrease in price, purchasing a number of mobile computing devices for a particular business environment may nonetheless represent a significant investment. Accordingly, for this reason, and potentially others, it may be advantageous to ensure that newly-acquired mobile computing devices are protected from damage, such as damage brought about by dropping a mobile computing device, spilling liquids on a mobile device, operating a mobile computing device in a dusty environment, and so forth.

However, particular mobile computing devices, such as tablet computing devices, for example, may be released to a market prior to development of suitable protective devices. Thus, after the purchase of, for example, a quantity of mobile computing devices for particular business applications, such as for use in hospital environments, industrial environments, and so forth, a business may refrain from deploying mobile devices until suitable protective covers and/or enclosures can be obtained. In other instances, a business may simply deploy newly-acquired mobile computing devices without protective coverings, for example, in hopes that the devices experience only minimal wear and tear until protective measures can be obtained.

### BRIEF DESCRIPTION OF THE DRAWINGS

Claimed subject matter is particularly pointed out and/or distinctly claimed in the concluding portion of the specification. However, both as to organization and/or method of operation, together with objects, features, and/or advantages thereof, claimed subject matter may be understood by reference to the following detailed description if read with the accompanying drawings in which:

FIG. 1 is a perspective view of a tablet computing device situated within a mobile computing device protector, according to an embodiment.

FIG. 2 is a perspective view of the mobile computing device protector shown in FIG. 1, wherein particular features of the mobile computing device protector are shown, according to an embodiment.

FIG. 3 is a perspective view showing of components of the mobile computing device protector shown in FIGS. 1 and 2, according to an embodiment.

FIG. 4 is a view showing a front portion of a liner of the mobile computing device protector shown in FIG. 3, according to an embodiment.

FIG. 5 is a perspective view showing a rear portion of the liner of the mobile computing device protector of FIG. 4, according to an embodiment.

In the following detailed description, reference is made to accompanying drawings, which form a part of the detailed description, wherein like numerals may designate like parts throughout the figures to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from the scope of claimed subject matter.

### DETAILED DESCRIPTION

Reference throughout this specification to “one example,” “one feature,” “one embodiment,” “an example,” “a feature,” “an implementation,” or “an embodiment” means that a particular feature, structure, or characteristic described in connection with the feature, example, or embodiment is included in at least one feature, example, or embodiment of claimed subject matter. Thus, appearances of the phrase “in one example,” “an example,” “in one implementation,” “an implementation,” “an embodiment,” or “in one embodiment” in various places throughout this specification are not necessarily all referring to the same feature, example, or embodiment. Particular features, structures, or characteristics may be combined in one or more examples, features, or embodiments.

As mentioned previously herein, certain businesses may place a premium on obtaining the most capable and/or most up-to-date mobile computing devices immediately after the mobile computing devices become available. As used herein, “mobile device,” “mobile communication device,” “mobile computing device,” or like terms may be used interchangeably and may refer to any kind of special purpose computing platform or apparatus that may from time to time occupy a position or location that changes. In some instances, a mobile communication device may, for example, be capable of communicating with other devices, mobile or otherwise, through wireless transmission and/or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), tablet computing devices, personal audio and/or video devices, personal navigation devices, or the like. It should be appreciated, however, that these are merely examples of mobile devices that may be used, at least in part, herein, and that claimed subject matter is not limited in this regard.

However, although many types of mobile computing devices, such as tablet computing devices, for example, continue to decrease in cost, purchasing a number of capable and/or feature-rich mobile computing devices may nonetheless represent a significant monetary investment. Accordingly, particularly for use within environments in which mobile computing devices are to be moved from place to place, such as in hospital environments, industrial environments, and so forth, it may be advantageous to ensure that mobile computing devices are protected within a case or other type of protective enclosure. However, on occasions, when mobile computing devices are introduced into a market, these devices may not be provided with adequate protective coverings, which may operate to protect a mobile computing device from shock, vibration, exposure to liquids and/or harsh chemicals, for example. Thus, a business or other entity that may have secured one or more mobile computing devices for deployment may be required to wait for perhaps several weeks or longer, for example, until suitable protective coverings can be manufactured and made available. Alternatively, rather than waiting for suitable protective coverings to become available, a business or other entity may simply decide to utilize newly-acquired mobile computing devices, even though such devices may be susceptible to damage and/or undue wear and tear.

In addition, it may be desirable for a protective covering of a mobile computing device to be compatible with portable and/or universal docking stations. For example, in a hospital setting, portable docking stations may be located at a number of locations throughout the hospital. Accordingly, at times, hospital personnel may wish to dock a mobile computing device at any locally available portable and/or “universal” docking stations, which may permit the mobile computing device to charge, receive and transmit parameters securely via a wired interface, receive updates via a wired interface, and so forth.

However, embodiments of claimed subject matter may represent an approach toward providing protective measures for mobile computing devices. Such measures may be made available in a more timely manner than previously possible and without requiring specialized, hardened metal tooling. In particular embodiments, approaches toward providing protective measures for mobile computing devices may involve design and manufacture of a single customized component, such as a mobile computing device protective liner, for example. In embodiments, a protective liner may be attached to a mobile computing device and attached to one or more non-customized components, such as components capable of being utilized across an entire family or size category of mobile computing products. In particular embodiments, such a combination of customized and non-customized components may comprise a complete protection solution for a mobile computing device. In addition, a complete protection solution may additionally provide interchangeability with universal docking stations, which may permit differently-sized mobile computing devices (e.g., 8-inch, 10-inch, 12-inch, and so forth) to be charged, updated, and/or to engage in secure communications, for example. Along these lines, at least some claimed subject matter may be directed to a protective, elastic liner meant adapt any mobile computing device within a particular size category (such as 8-inch, 10-inch, 12-inch, and so forth) to a universal docking station.

Thus, in particular embodiments, a mobile computing device protector may be formed from a customized component and one or more components utilized across, for example, families of nominally 8-inch, 10-inch, 12-inch, or other sized mobile computing devices. For example, as described herein, a mobile computing device protector may comprise a bezel, which may be placed at least partially in contact with a first side, which refers to a display side, of a mobile computing device. The bezel may be attached to a mobile computing device protector liner, which may be placed at least partially in contact with a second side (which refers to a non-display side of a mobile computing device), thereby retaining the mobile computing device between the liner and the bezel. A mobile computing device protector may additionally comprise a back portion, which may be utilized, at least in part, to fasten together the mobile computing device protector liner, bezel, and back portion so as to form a mobile computing device protector. As will be shown and described, embodiments, fastening of a back portion to a mobile computing device protective liner and bezel may additionally provide an approach toward mounting the mobile computing device to a universal docking station, for example. In particular embodiments, a back portion of a mobile computing device protector may comprise additional features, such as features to permit the mobile computing device protector to be secured to a hand and/or shoulder strap, for example. In embodiments, use of a hand and/or shoulder strap, may permit the mobile computing device to be carried from place to place with a reduced risk of being dropped, for example.

A protective liner may be manufactured from any suitable material, such as elastic material, for example, capable of facilitating and/or supporting one or more approaches and/or objectives discussed herein. For example, in at least one implementation, a mobile computing device protective liner may be manufactured from a moldable relatively elastic material, having a Shore durometer measurement of between 55.0 (A) and 85.0 (A). In other embodiments, an elastic material utilized to form a mobile computing device protective liner may comprise a Shore durometer measurement of between 70.0 (A) and 80.0 (A). In other embodiments, an elastic material utilized to form a mobile computing device protective liner may comprise a Shore barometer measurement of between 40.0 (A) and 95.0 (A) (or even as high as 100.0 (A), for example). However, claimed subject matter is intended to embrace protective liners comprising any predetermined Shore durometer measurement. Use of elastic materials having such Shore durometer measurements may operate as a cushion in the event that the mobile computing device is accidentally dropped, for example. In addition, an elastic protective liner may provide a relatively tight, snug, and/or secure fit around contours of mobile computing devices in a way that may mitigate or prevent exposure of surfaces of the mobile computing device to cleaning solvents, dust, chemicals, water, etc., which may permit the mobile computing device to operate relatively trouble-free for extended periods of time. In embodiments, liner 120 may comprise a thickness of between 1.0 mm and 3.0 mm, although claimed subject matter is not limited in this regard. In particular embodiments, liner 120 may comprise a front-to-back thickness of between 1.0 cm and 3.0 cm although, again, claimed subject matter is not limited in this respect. For example, in other embodiments, liner 120 may comprise a front-to-back thickness of 0.75 cm, for example, or may comprise a front-to-back thickness of 3.5 cm, or greater.

A mobile computing device protective liner may comprise a number of ribs, which may operate to further reduce likelihood of damage to the mobile computing device responsive to exposure to shock and/or vibration, for example. In addition, a mobile computing device protector may provide features such as holes and/or cutouts to accommodate, for example, a mobile computing device camera. Further, one or more vents may be situated in a mobile computing device protective liner to correspond with locations at which fans and/or other heat dissipation measures are located on a particular mobile computing device. In embodiments, a mobile computing device protective liner may provide one or more recesses, within which one or more membranes may be located wherein the membranes correspond to locations at which switches are positioned on a particular type of mobile computing device. A mobile computing device protective liner may additionally incorporate a cable race, for example, to accommodate a cable utilized for charging of the mobile computing device, for example, without removing the mobile computing device from a device protector.

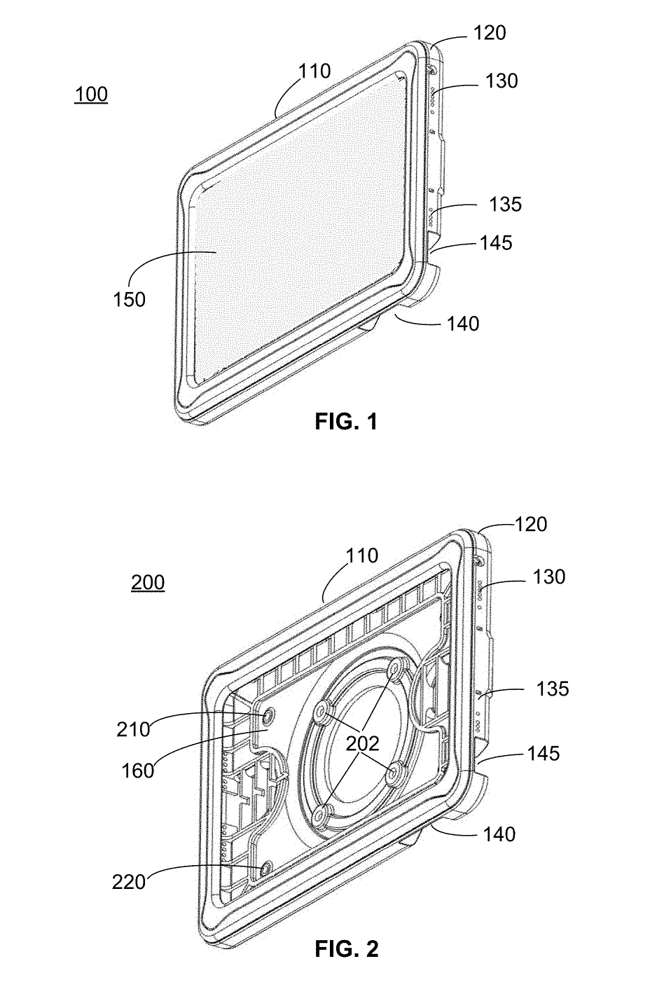

FIG. 1 is a perspective view of a tablet computing device 150 situated within a mobile computing device protector, according to an embodiment 100. Bezel 110 is shown in FIG. 1 as surrounding, such as at a perimeter portion of a display of tablet computing device 150. However, in particular embodiments, bezel 110 may surround only a portion of a display of tablet computing device 150, and claimed subject matter is not limited in this respect. In addition, although bezel 110 is shown in FIG. 1 as not encroaching upon and/or covering the display of tablet computing device 150, in particular embodiments may include a bezel that encroaches and/or covers some portion of a display of tablet computing device 150, for example.

Mobile computing device cover protective liner 120, which may be referred to as “liner” 120, may be coupled and/or connected to bezel 110 in a manner that tightly and/or snugly envelops tablet computing device 150. As shown in FIG. 1, protective liner 120 may incorporate vents 130 and 135 which may, for example, correspond to the vents located on tablet computing device 150. Accordingly, via positioning of the vents 130 and 135, for example, heat dissipation, airflow and/or other parameters of tablet computing device 150 may be maintained or only minimally impacted. Liner 120 may additionally comprise recesses 140 and 150 which may correspond to locations at which selector buttons, volume controls, etc. may be situated on a surface of tablet computing device 150.

FIG. 2 is a perspective view of the mobile computing device cover of FIG. 1, showing particular features according to an embodiment 200. In FIG. 2, with tablet computing device 150 removed, additional features of liner 120 as well as mobile computing device protector back portion 160 (referred to as back portion 160) may also be viewed. Accordingly, mobile computing device back portion 160 shows four screw holes 202, which may provide compatibility with VESA (Video Electronics Standards Association) mounting brackets. However, in other embodiments, screw holes 202 may be fewer in number, such as including three or fewer screw holes, or may be greater in number, such as including five or greater screw holes, and claimed subject matter is not limited in this respect. Mobile computing device back portion 160 may additionally include screw holes 210 and 220 which may, for example, accommodate a hand and/or shoulder strap, for example, D-ring fasteners, and so forth, which may permit a tablet computing device to be carried from place to place.

In addition to providing compatibility of back portion 160 with VESA mounting brackets, back portion 160 may additionally be compatible and/or interchangeable with a number of portable docking stations, which may be available throughout a hospital, industrial facility, and so forth. In embodiments, back portion 160 may provide a capability to mount a number of differently-sized mobile computing devices to a portable docking station. For example, back portion 160 may permit an 8-inch mobile computing device, 10-inch mobile computing device, 12-inch mobile computing device, and/or differently-sized mobile computing device to be physically connected with a single, universal portable docking station. Accordingly, a single, universal portable docking station may be utilized to charge and/or facilitate updates to an 8-inch mobile computing device, a 10-inch mobile computing device, and a 12-inch mobile computing device, (but not simultaneously) within a single business day.

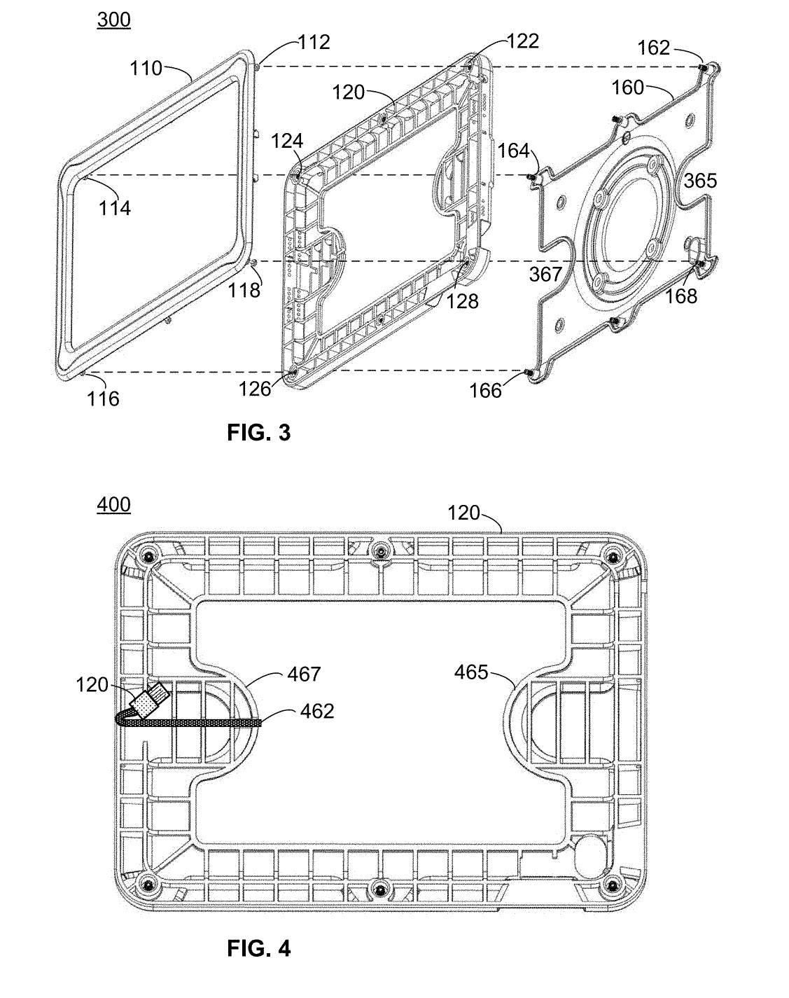

FIG. 3 is a perspective view showing of components of the mobile computing device cover of FIGS. 1 and 2 according to an embodiment 300. In embodiments, the bezel 110 and mobile computing device back portion 160 may comprise a hard plastic and/or metallic material comprising sufficient to retain liner 120 and tablet computing device 150 between bezel 110 and back portion 160. As shown in FIG. 3, to assemble a mobile computing device protector, screw 162 of back portion 160 may be fit through screw hole 102 of liner 120 so as to mate with screw boss 112 of bezel 110. Similarly, screw 164 of back portion 160 may fit through screw hole 124 of liner 120 so as to mate with screw boss 114 of bezel 110. Likewise, screw 166 may fit through screw hole 126 so as to mate with screw boss 116. Further, screw 168 of back portion 160 may fit through screw hole 128 so as to mate with screw boss 118. It should be noted that assembly of bezel 110, liner 120, and back portion 160 may be accomplished by any number of additional approaches, perhaps using a larger or smaller number of screws, screw holes, and screw bosses, for example, and claimed subject matter is not limited in this respect. Mobile computing device back portion 160 may additionally comprise indents 365 and 367, which may align with features of liner 120, described with respect to FIG. 4.

FIG. 4 is a view showing a front portion of a liner of the mobile computing device cover shown in FIG. 3, according to an embodiment 400. In the embodiment of FIG. 4, protective liner 120 may comprise outcrops 466 and 467, which may mate with indents 365 and 367. In embodiments, outcrops 466, for example, may correspond to a location of a camera on a tablet computing device for example. In such an instance, outcrops 466 may be easily removed, or a mold utilized to form outcrops 466, for example, may be modified so as to be excluded from liner 120, thereby permitting visibility of a camera lens. Outcrop 467 may additionally comprise a cable race, which may permit a cable to be inlaid within liner 120. As previously mentioned, and ability for liner 120 to accommodate a cable, such as cable 462, may permit charging of a tablet computing device while operation within a mobile computing device cover, for example.

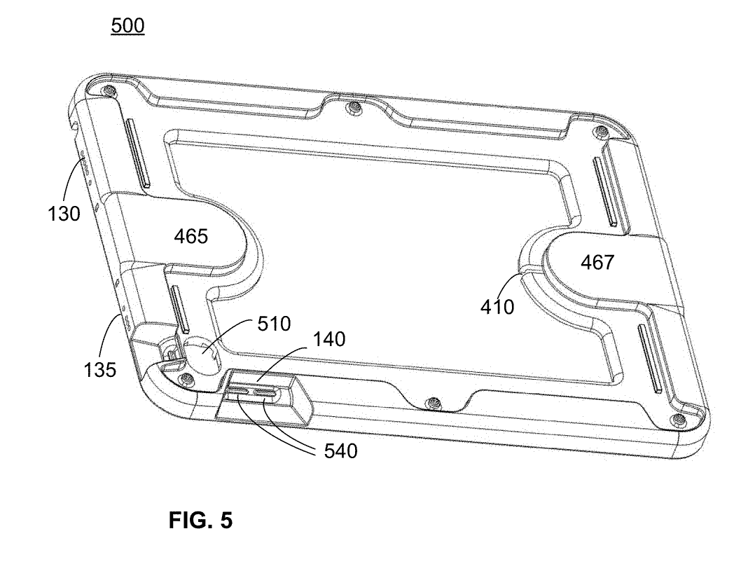

FIG. 5 is a perspective view showing a rear portion of a liner of the mobile computing device cover of FIG. 4, according to an embodiment 500. FIG. 5 illustrates an additional camera hole 510 along with the membranes 540, which may be positioned within recess 140. In embodiments, membranes 540 may comprise a thickness of, for example, 0.25 mm to 1.5 mm, thereby permitting a user to depress volume control buttons, selector switches, and/or perform other control functions on a tablet computing device while the tablet computing device is enclosed within a cover. In embodiments, membranes 540 may comprise a thickness so as to permit depression of a selector switch having an area of as little as 0.5 cm², however, claimed subject matter is not limited in this respect.

In the present patent application, terms such as “over” and “under” are understood in a similar manner as the terms “up,” “down,” “top,” “bottom,” “upward,” “downward,” and so on, as previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean I, J, and K, here used in the inclusive sense, as well as A, B, or C here used in the exclusive sense. With this understanding, “and” is used in the inclusive sense and intended to mean A, B, or C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to teachings of claimed subject matter without departing from the central concept(s) described herein. Therefore, it is intended that claimed subject matter not be limited to particular examples disclosed, but that such claimed subject matter may also include all aspects falling within appended claims and/or equivalents thereof.

What is claimed is:

1. A method of protecting at least a portion of a computing device, comprising:
fitting a bezel around at least a portion of a perimeter of a first side of a mobile computing device; and
coupling a liner to the bezel at a second side, opposite the first side of the mobile computing device, the liner substantially comprising an elastic material having a predetermined Shore durometer measurement.

2. The method of claim 1, additionally comprising:
fitting a support structure to the liner and the bezel.

3. The method of claim 1, wherein the predetermined Shore durometer measurement comprises a value of between 40.0 (A) and 100.0 (A).

4. The method of claim 1, wherein the predetermined Shore durometer measurement comprises a value of between 55.0 (A) and 85.0 (A).

5. A system capable of protecting at least a portion of a computing device, comprising:
a liner substantially comprising an elastic material having predetermined Shore durometer measurement, the liner fitting adjacent to a non-display side of the computing device; and
a bezel capable of fitting around at least a portion of a perimeter of display side of the computing device.

6. The system of claim 5, wherein the predetermined Shore durometer measurement comprises between 55.0 (A) and 85.0 (A)

7. The system of claim 5, further comprising:
one or more recesses capable of accepting one or more screw bosses of the bezel.

8. The system of claim 5, wherein the elastic material of the liner comprises a plurality of elastic ribs.

9. The system of claim 5, wherein the Shore durometer of the elastic material comprises between 70.0 (A) and 80.0 (A).

10. The system of claim 5, wherein the liner further comprises a membrane having a thickness to permit force applied at an outer surface of the liner to be received at an approximately 0.5 cm² selector button located on a surface of the computing device.

11. The system of claim 10, wherein the membrane comprises a thickness of between 0.25 mm and 1.5 mm.

12. The system of claim 5, wherein the elastic material comprises a front-to-back thickness of between 1.0 cm and 3.0 cm.

13. A liner capable of providing protection to one or more sides of a computing device, comprising:
a main section having a thickness of between about 1.0 cm and 3.0 cm and comprising an elastic material having a predetermined Shore durometer measurement; and
one or more membranes having a thickness of between about 0.25 mm and 1.5 mm.

14. The liner of claim 13, wherein the predetermined Shore durometer measurement comprises a Shore durometer measurement of between about 55.0 (A) and about 85.0 (A).

15. The liner of claim 13, wherein the liner is capable of fitting to a non-display side of a tablet computing device, the liner further comprising one or more recesses for accepting one or more screw bosses from a bezel, the bezel capable of fitting around a display side of the tablet computing device.
